(19) United States
(12) Patent Application Publication
(10) Pub. No.: US 2024/0355189 A1
(43) Pub. Date: Oct. 24, 2024

(54) METHODS AND SYSTEMS FOR PROVIDING A USER WITH ORAL CARE FEEDBACK

(71) Applicant: KONINKLIJKE PHILIPS N.V., EINDHOVEN (NL)

(72) Inventors: Brian Esley TIDBALL, Bothell, WA (US); Jose Martin VILLAR DURAN, Lake Forest Park, WA (US); Nathan FARRELL, Kirkland, WA (US); Gul DIKMEN, Bothell, WA (US); Robert Joseph Leigh PHIBBS, Seattle, WA (US); Ivonne LABADIE LEZAMA, Bothell, WA (US); Chelsea PEREIRA, Bothell, WA (US); Elizabeth Michelle STARKE, Seattle, WA (US)

(21) Appl. No.: 18/034,421

(22) PCT Filed: Oct. 25, 2021
(86) PCT No.: PCT/EP2021/079438

§ 371 Date: Apr. 28, 2023

Related U.S. Application Data
(60) Provisional application No. 63/107,104, filed on Oct. 29, 2020.

(30) Foreign Application Priority Data
Nov. 16, 2020 (EP) 20207749.1

(51) Int. Cl. G08B 21/24; A46B 13/02; A46B 15/00

(52) U.S. Cl. CPC G08B 21/24; A46B 13/02; A46B 15/0008; A46B 2200/1066

(57) ABSTRACT

The invention provides a method for encouraging a user to perform an oral care routine using an oral care device for a predetermined period of time. The method includes recording a plurality of previous oral care sessions, the previous oral care sessions including at least one oral care session ending before the predetermined period of time has elapsed after the user has begun the oral care session. An oral care time characteristic is calculated based on the plurality of previous oral care sessions and, for a subsequent oral care session, a point in time after the user has begun performing an oral care routine is determined for providing the user with feedback based on the oral care time characteristic. The user is then provided with feedback at the determined point in time during the subsequent oral care session.

### FIELD OF THE INVENTION

The invention relates to the field of oral care, and more specifically to the field of oral care monitoring.

### BACKGROUND OF THE INVENTION

It is common for users of powered toothbrushes, and other oral care devices, to stop an oral care routine before reaching the recommended length of time for performing said routine. For example, in the case of powered toothbrushes, users often end a tooth brushing session before the end of the recommended two minute brushing routine. In particular, some users regularly and consistently do not complete the recommended two minute brushing routine. Ending an oral care routine before reaching the recommended length of time for performing said routine can lead to incomplete oral care coverage and oral health complications.

Many existing powered toothbrushes have systems that indicate the passing of time through indicators of various types being activated at regular intervals, which may indicate to the user when to switch between different areas of the mouth.

Despite the provision of feedback at regular intervals, many users still do not complete the recommended two minute brushing routine when using a powered toothbrush.

There is therefore a need for a means increasing the number of users that complete the recommended length of time for performing an oral care routine on a regular basis.

### SUMMARY OF THE INVENTION

The invention is defined by the claims.

According to examples in accordance with an aspect of the invention, there is provided a method for encouraging a user to perform an oral care routine using an oral care device for a predetermined period of time, the method comprising:
recording a plurality of previous oral care sessions, the previous oral care sessions including at least one oral care session ending before the predetermined period of time has elapsed after the user has begun the oral care session;
calculating an oral care time characteristic based on the plurality of previous oral care sessions;
determining, for a subsequent oral care session, a point in time after the user has begun performing an oral care routine for providing the user with feedback based on the oral care time characteristic; and
providing the user with feedback at the determined point in time during the subsequent oral care session.

The method is computer-implemented. The recording of the plurality of previous oral care sessions involves recording an oral care time.

The method provides a means for providing personalized feedback to a user based on the length of time for which the user performs an oral care routine.

In this way, feedback may be provided to the user at the optimal time during a subsequent oral care session in order to encourage the user to perform the oral care routine for the predetermined period of time.

As the timing of the feedback is determined on a user specific basis, the feedback is more likely to successfully encourage an individual user to perform the oral care routine for the predetermined period of time.

In an embodiment, the feedback comprises one or more of:
a light signal;
a sound signal;
a tactile signal; and
an electrical signal.

In this way, the feedback may be provided to a user using any suitable means.

In an embodiment, recording an oral care time for a previous oral care session comprises one or more of:
automatically recording the oral care time by starting a timer when the oral care device is turned on and stopping the timer when the oral care device is turned off;
determining the oral care time based on a motion signal obtained by a motion sensor of the oral care device;
determining the oral care time based on a pressure signal obtained by a pressure sensor of the oral care device; and
determining the oral care time based on a sound signal obtained by a microphone in the vicinity of the oral care device.

In this way, the recordings of the previous oral care sessions may be collected automatically as the user uses the oral care device by way of a timer, pressure sensor, motion sensor or microphone. By automatically recording the oral care sessions, the method does not require any active input from the user in order to be effective.

In an embodiment, the method further comprises updating the oral care time characteristic based on the subsequent oral care session.

In this way, the point in time at which the feedback is provided to the user during subsequent oral care sessions may be altered in order to maintain optimal feedback timing.

In a further embodiment, updating the oral care time characteristic comprises calculating a moving average based on each subsequent oral care session.

In this way, only the oral care sessions that describe the most relevant oral care times of the user may be used to determine the feedback timing.

According to examples in accordance with an aspect of the invention, there is provided a computer program product comprising computer program code means which, when executed on a computing device having a processing system, cause the processing system to perform all of the steps of the methods described above.

According to examples in accordance with an aspect of the invention, there is provided a processing unit for encouraging a user to perform an oral care routine using an oral care device for a predetermined period of time, wherein the processing unit is adapted to:
obtain a plurality of recordings of previous oral care sessions, the previous oral care sessions including at least one oral care session ending before the predetermined period of time has elapsed after the user has begun the oral care session;
calculate an oral care time characteristic based on the plurality of previous oral care sessions;
determine, for a subsequent oral care session, a point in time after the user has begun an oral care routine for providing the user with feedback based on the oral care time characteristic; and
generate a signal for providing the user with feedback at the determined point in time during the subsequent oral care session.

According to examples in accordance with an aspect of the invention, there is provided a system for encouraging a user to perform an oral care routine for a predetermined period of time, the system comprising:
an oral care device;
the processing unit as described above;
a recording unit in communication with the processing unit adapted to record the plurality of previous oral care sessions; and
a feedback unit in communication with the processing unit adapted to provide the user with feedback at the determined point in time.

In an embodiment, the processing unit, the recording unit and the feedback unit are incorporated into the oral care device.

In an embodiment, the oral care device comprises one or more of:
a powered toothbrush;
a powered brushing mouthpiece;
a powered flossing device; and
a powered tooth whitening device.

In an embodiment, the recording unit comprises one or more of:
a timer;
a motion sensor;
a microphone; and
a pressure sensor.

In an embodiment, the processing unit is incorporated into a smart device, such as:
a smartphone;
a smartwatch; and
a smart home device;
wherein the oral care device further comprises a communication unit in communication with the processing unit.

In an embodiment:
the feedback unit is further incorporated into the smart device;
the feedback unit is incorporated into the oral care device, wherein the feedback unit is in communication with the communication unit; or
the feedback unit is incorporated into a charging unit, wherein the charging unit is adapted to charge the oral care device.

In an embodiment:
the recording unit is incorporated into the smart device;
the recording unit is incorporated into the oral care device, wherein the recording unit is in communication with the communication unit or
the recording unit is incorporated into a charging unit, wherein the charging unit is adapted to charge the oral care device.

In an embodiment, the feedback unit comprises one or more of:
a light source;
a speaker;
a tactile feedback unit; and
an electrical signal generator.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a method for encouraging a user to perform an oral care routine using an oral care device for a predetermined period of time;

FIG. 2 shows a schematic representation of a powered toothbrush as an oral care device according to an aspect of the invention;

FIG. 3 shows a schematic representation of an oral care system according to an aspect of the invention; and

FIG. 4 shows a schematic representation of an oral care system according to a further aspect of the invention.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a method for encouraging a user to perform an oral care routine using an oral care device for a predetermined period of time. The method includes recording a plurality of previous oral care sessions, the previous oral care sessions including at least one oral care session ending before the predetermined period of time has elapsed after the user has begun the oral care session. An oral care time characteristic is calculated based on the plurality of previous oral care sessions and, for a subsequent oral care session, a point in time after the user has begun performing an oral care routine is determined for providing the user with feedback based on the oral care time characteristic. The user is then provided with feedback at the determined point in time during the subsequent oral care session.

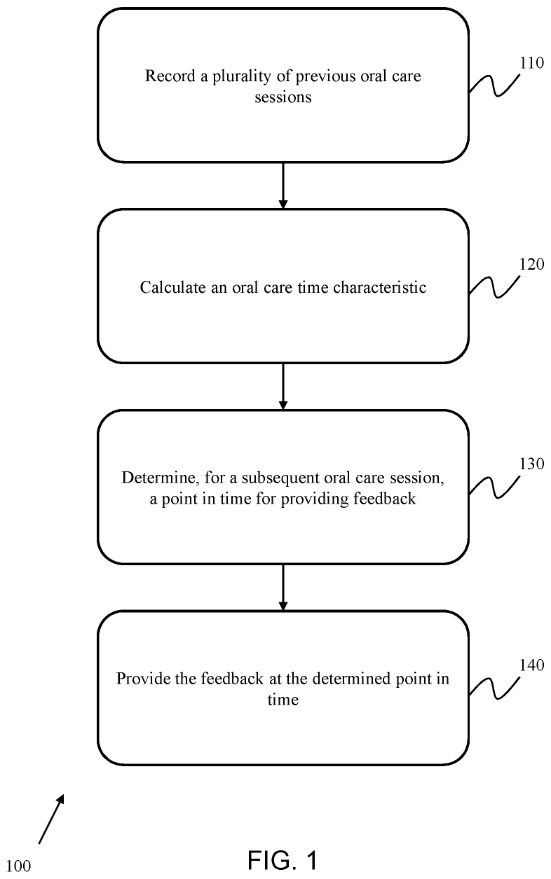

FIG. 1 shows a method 100 for encouraging a user to perform an oral care routine using an oral care device for a predetermined period of time.

The oral care device may include one or more of: a powered toothbrush; a powered brushing mouthpiece; a powered flossing device; and a powered tooth whitening device. The method of FIG. 1 will be described in the context of a powered toothbrush in order to provide an exemplary illustration of how the method may be implemented in an oral care environment. However, it should be noted that the methods described herein may be applied to any of the oral care devices listed above, or indeed any suitable powered oral care device.

The method begins at step 110, by using a recording unit to record a plurality of previous oral care sessions, in particular oral care times, the previous oral care sessions including at least one oral care session ending before the predetermined period of time has elapsed after the user has begun the oral care session.

For example, in the case of the oral care device being a powered toothbrush, each time the user brushes their teeth using the powered toothbrush, the tooth brushing session may be recorded as an oral care session. Over multiple recorded oral care sessions, it is possible to identify the typical brushing, or oral care, behaviors of the given user.

For example, if the user always brushes their teeth for at least the recommended two minute time period, they may not require any further encouragement to perform the oral care routine for the predetermined period of time. The recording of oral care sessions may be ongoing in order to ensure that the user maintains the predetermined period of time for performing the oral care routine.

However, if a user does end an oral care session before the predetermined period of time has elapsed, they may benefit from receiving feedback to encourage them to perform the oral care routine to the completion of the predetermined period of time.

Recording the plurality of previous oral care sessions may be performed in a number of ways. For example, recording an oral care time for a previous oral care session may comprise one or more of: automatically recording the oral care time by starting a timer when the oral care device is turned on and stopping the timer when the oral care device is turned off; determining the oral care time based on a motion signal obtained by a motion sensor of the oral care device; determining the oral care time based on a pressure signal obtained by a pressure sensor of the oral care device; and determining the oral care time based on a sound signal obtained by a microphone in the vicinity of the oral care device.

In step 120, an oral care time characteristic is calculated based on the plurality of previous oral care sessions.

The oral care time characteristic may be any characteristic relating to the time of the oral care sessions. For example, the oral care time characteristic may include one or more of: a minimum time spent performing an oral care routine; an average time spent performing an oral care routine; a variance in the time spent performing an oral care routine; an average time of day when an oral care routine is performed; a frequency of an oral care routine being performed; and the like.

It should be noted that the oral care time characteristic may be updated with each subsequent oral care session. For example, updating the oral care time characteristic may include calculating a moving average, such as a moving average time spent performing an oral care routine, based on each subsequent oral care session.

In step 130, it is determined, for a subsequent oral care session, a point in time after the user has begun performing an oral care routine for providing the user with feedback based on the oral care time characteristic.

For example, it may be determined that the feedback should be provided before, or when, the minimum oral care time is reached. Alternatively, it may be determined that the feedback should be provided before, or when, the average oral care time is reached. Further, it may be determined that, when an oral care routine is performed at a certain time of day, the average oral care time may differ from other times of day when an oral care routine is performed, meaning that the feedback may be provided at different points in a subsequent oral care session based on the time of day the subsequent oral care routine is performed. In the example of the user brushing their teeth in the morning and the evening, the user may require feedback at a different point in time during the morning oral care session than in the evening oral care session.

In this way, the user receives the feedback to encourage them to continue the oral care routine, such as brushing their teeth, before they would typically end the oral care routine, thereby ensuring that the user receives the feedback whilst still performing the oral care routine.

The determination of the point in time to provide the user with feedback may be computed using any suitable algorithm. Further, the oral care time characteristics may be provided to a machine learning algorithm as an input and in order to generate a recommended point in time to provide the feedback as an output.

A machine-learning algorithm is any self-training algorithm that processes input data in order to produce or predict output data. Here, the input data comprises oral care time characteristics and the output data comprises a recommended point in time for providing a user with feedback.

Suitable machine-learning algorithms for being employed in the present invention will be apparent to the skilled person. Examples of suitable machine-learning algorithms include decision tree algorithms and artificial neural networks. Other machine-learning algorithms such as logistic regression, support vector machines or Naïve Bayesian models are suitable alternatives.

The structure of an artificial neural network (or, simply, neural network) is inspired by the human brain. Neural networks are comprised of layers, each layer comprising a plurality of neurons. Each neuron comprises a mathematical operation. In particular, each neuron may comprise a different weighted combination of a single type of transformation (e.g. the same type of transformation, sigmoid etc. but with different weightings). In the process of processing input data, the mathematical operation of each neuron is performed on the input data to produce a numerical output, and the outputs of each layer in the neural network are fed into the next layer sequentially. The final layer provides the output.

Methods of training a machine-learning algorithm are well known. Typically, such methods comprise obtaining a training dataset, comprising training input data entries and corresponding training output data entries. An initialized machine-learning algorithm is applied to each input data entry to generate predicted output data entries. An error between the predicted output data entries and corresponding training output data entries is used to modify the machine-learning algorithm. This process can be repeated until the error converges, and the predicted output data entries are sufficiently similar (e.g. ±1%) to the training output data entries. This is commonly known as a supervised learning technique.

For example, where the machine-learning algorithm is formed from a neural network, (weightings of) the mathematical operation of each neuron may be modified until the error converges. Known methods of modifying a neural network include gradient descent, backpropagation algorithms and so on.

The training input data entries correspond to example oral care time characteristics. The training output data entries correspond to recommended points in time for providing feedback to the user.

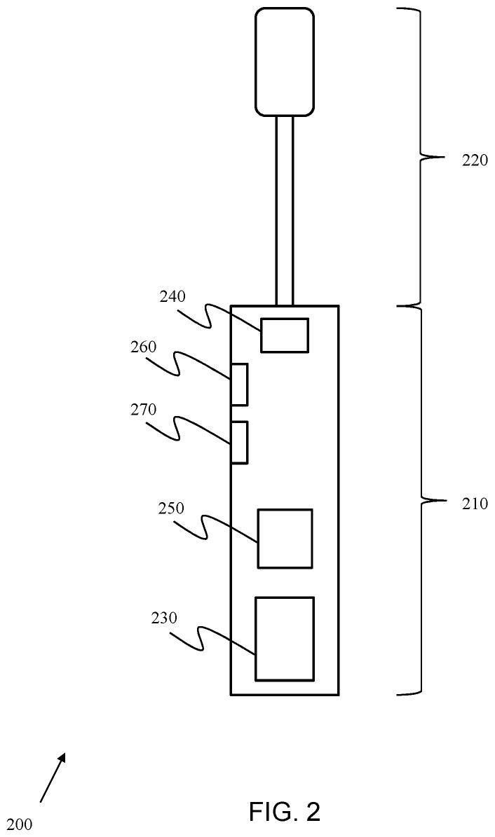

In step 140, a feedback unit is controlled to provide feedback to the user at the determined point in time during the subsequent oral care session. The feedback may comprise one or more of: a light signal; a sound signal; a tactile signal; and an electrical signal. The feedback unit is controlled by a signal provided by a processing unit as discussed below. FIG. 2 shows a schematic representation of a powered toothbrush 200 as an oral care device, which may form at least part of a system for encouraging a user to perform an oral care routine for a predetermined period of time. The powered toothbrush may comprise a body portion 210 and a brush head portion 220, wherein the brush head portion is adapted to be provided to a user's mouth for performing an oral care routine. The body portion 210 of the powered toothbrush 200 may include a battery 230 and a drive unit 240 for operating the brush head portion 220.

In the example shown in FIG. 2, the powered toothbrush 200 includes a processing unit 250 for encouraging a user to perform an oral care routine using an oral care device for a predetermined period of time. The processing unit may be adapted to implement the methods described above with reference to FIG. 1.

More specifically, the processing unit 250 may be adapted to obtain a plurality of recordings of previous oral care sessions, the previous oral care sessions including at least one oral care session ending before the predetermined period of time has elapsed after the user has begun the oral care session; calculate an oral care time characteristic based on the plurality of previous oral care sessions; determine, for a subsequent oral care session, a point in time after the user has begun an oral care routine for providing the user with feedback based on the oral care time characteristic; and generate a signal for providing the user with feedback at the determined point in time during the subsequent oral care session.

In the example shown in FIG. 2, the powered toothbrush comprises a recording unit 260, adapted to record the plurality of previous oral care sessions, and a feedback unit 270 adapted to provide the user with feedback at the determined point in time.

The recording unit 260 may comprise one or more of: a timer; a motion sensor; a pressure sensor; and a microphone.

For example, the recording unit may comprise a timer, wherein the timer is adapted to start timing an oral care session when the user turns the oral care device on and stop timing the oral care session when the user turns the oral care device off.

In a further example, the recording unit may comprises a motion sensor, such as an accelerometer, a gyroscope and/or an inertial measurement unit. In the case where the recording unit comprises a motion sensor, the recording unit may be adapted to begin recording an oral care session when a movement is detected that corresponds to the user interacting with the oral care device. The recording unit may stop recording the oral care session when the motion sensor no longer detects any motion for a predetermined length of time, such as 10 seconds. In the example shown in FIG. 2, the motion sensor may be located at any point within the powered toothbrush.

In a further example, the recording unit may include a pressure sensor, in which case the recording unit may be adapted to begin recording an oral care session when a change in pressure is detected that corresponds to the user interacting with the oral care device. For example, if the pressure sensor is located in the brush body 210, the change in pressure may correspond to the user gripping the brush body. Alternatively, if the pressure sensor is located within the brush head 220, the change in pressure may correspond to the brush head entering the user's mouth. In a further alternative example, if the pressure sensor is located at the base of the brush body, the change in pressure may correspond to the oral care device being picked up. The recording unit may stop recording the oral care session when the pressure sensor senses a change in pressure restoring the pressure reading to the level recorded before the session began, for example, when the user releases the oral care device, the oral care device leaves the user's mouth or the oral care device is set down.

In a yet further example, the recording unit may comprise a microphone, in which case the recording unit may be adapted to begin recording an oral care session when a sound associated with the oral care session is detected. The sound may be any suitable trigger sound, such as, the sound of the driving unit or the sound of teeth being brushed. Alternatively, the user may speak a command word to be detected by the microphone, which is intended to begin the recording of the oral care session. The recording unit may stop recording the oral care session when the microphone ceases to detect the trigger sound or the user speaks a command word intended to end the recording of the oral care session.

The feedback unit 270 may comprise one or more of: a light source; a speaker; a tactile feedback unit; and an electrical signal generator.

For example, if the feedback unit comprises a light source, the feedback may comprise one or more of: a constant light; a blinking light; a change in light color; and the like. If the feedback unit comprises a speaker, the feedback may comprise one or more of: a brief audible note; an elongated audible note; a repeating audible note; a plurality of audible notes; and the like. If the feedback unit comprises a tactile feedback unit, such as a vibration unit, the feedback may comprise one or more of: a brief tactile signal; an elongated tactile signal; a repeating tactile signal; a plurality of tactile signals; and the like. If the feedback unit comprises an electrical signal generator, the feedback may, for example, comprise an electrical signal adapted to alter the behavior of the oral care device in order to provide the user with feedback. For example, the electrical signal generator may generate a signal to briefly alter the behavior of the drive unit in order to provide the user with the feedback.

If the feedback unit comprises more than one of the feedback means described above, the user may select their preferred feedback type.

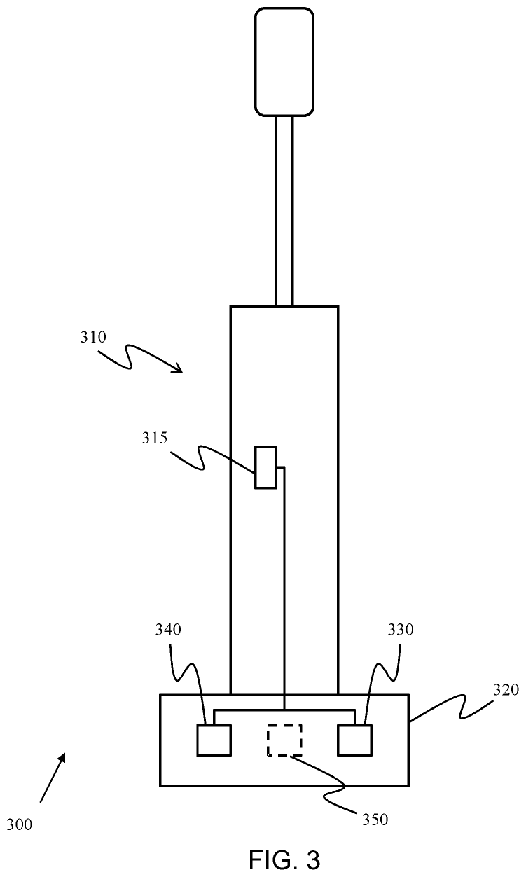

FIG. 3 shows a schematic representation of an oral care system 300, wherein the oral care device 310 is a powered toothbrush comprising a recording unit 315, such as the recording units described above with reference to FIG. 2.

In the example shown in FIG. 3, the oral care system 300 comprises a charging unit 320 adapted to receive, and charge, the oral care device 310. Further, the charging unit 320 comprises a processing unit 330 and a feedback unit 340. The processing unit and feedback unit may be implemented as described above with reference to FIG. 2. In other words, the processing unit and feedback unit may be provided in the charging unit of the oral care system rather than the oral care device itself. The recording unit of the oral care device may be brought into communication with the processing unit when the oral care device is brought into contact with the charging unit.

Alternatively, the processing unit may be provided in the oral care device and the feedback unit may be provided in the charging unit, or vice versa. The oral care device and the charging unit may comprise communication units to establish wireless communication between the oral care device and the charging unit when they are not physically connected.

Further, the charging unit may comprise a recording unit 350, such as a pressure sensor or a microphone as described above. Alternatively, the recording unit may comprise a timer adapted to start timing an oral care session when the user removes the oral care device from the charging unit and stop timing the oral care session when the user returns the oral care device to the charging unit.

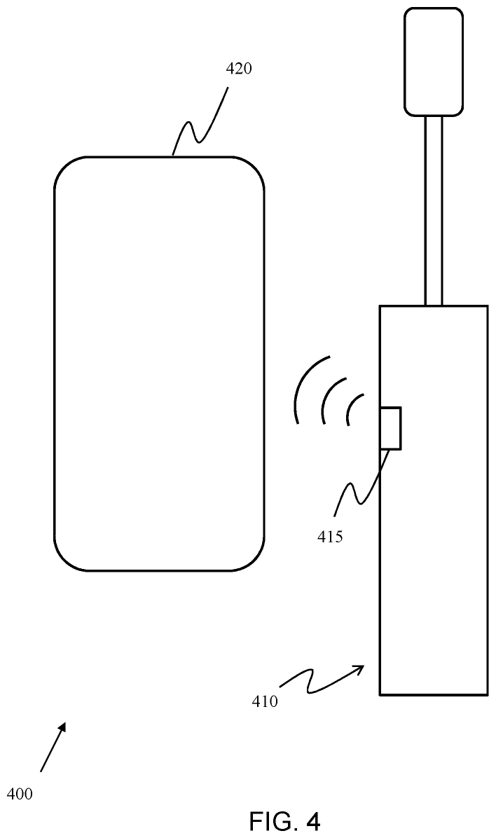

FIG. 4 shows a schematic representation of an oral care system 400, wherein the oral care device 410 is a powered toothbrush comprising a communication unit 415 in wireless communication with a smart device 420.

In the example shown in FIG. 4, the smart device 420 is a smartphone; however, the smart device may comprise one or more of: a smartphone: a smartwatch; and a smart home device.

One or more of the processing unit, the feedback unit and the recording unit may be incorporated into the smart device.

For example, the recording unit may be incorporated into the oral care device as described above with reference to FIG. 2. The recorded oral care time may then be provided to the smart device, which includes the processing and feedback units, by way of the communication unit 415. The smart device may generate any suitable type of feedback as described above, such as: a light signal, provided by way of a display; an audible signal, provided by way of a speaker; a tactile signal, for example by generating a vibration; and an electrical signal, which may be communicated to the communication unit of the oral care device to alter a behavior of the oral care device or used to alter an aspect of the smart device to communicate the feedback to the user.

Alternatively, the smart device may include a recording unit comprising a microphone as described above. Further, if the smart device is a smart watch, the smart device may include a recording unit comprising a motion sensor.

It should be noted that any combination of the embodiments described in FIGS. 2 to 4 may also be achieved. For example, the recording unit may be incorporated into the oral care device, the processing unit may be incorporated into the smart device and the feedback unit may be incorporated into the charging unit, each component being linked by one or more communication units.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

A single processor or other unit may fulfill the functions of several items recited in the claims.

The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

If the term “adapted to” is used in the claims or description, it is noted the term “adapted to” is intended to be equivalent to the term “configured to”.

Any reference signs in the claims should not be construed as limiting the scope.

1. A computer-implemented method for encouraging a user to perform an oral care routine using an oral care device for a predetermined period of time, the method comprising:
recording an oral care time for a plurality of previous oral care sessions, the previous oral care sessions including at least one oral care session ending before the predetermined period of time has elapsed after the user has begun the oral care session;
calculating an oral care time characteristic based on the plurality of previous oral care sessions;
determining, for a subsequent oral care session, a point in time after the user has begun performing an oral care routine for providing the user with feedback based on the oral care time characteristic; and
controlling a feedback unit to provide the user with feedback at the determined point in time during the subsequent oral care session.

2. A method as claimed in claim 1, wherein the feedback comprises one or more of:
a light signal;
a sound signal;
a tactile signal; and
an electrical signal.

3. A method as claimed in claim 1, wherein recording an oral care time for a previous oral care session comprises one or more of:
automatically recording the oral care time by starting a timer when the oral care device is turned on and stopping the timer when the oral care device is turned off;
determining the oral care time based on a motion signal obtained by a motion sensor of the oral care device;
determining the oral care time based on a pressure signal obtained by a pressure sensor of the oral care device; and
determining the oral care time based on a sound signal obtained by a microphone in the vicinity of the oral care device.

4. A method as claimed in claim 1, wherein the method further comprises updating the oral care time characteristic based on the subsequent oral care session.

5. A method as claimed in claim 4, wherein updating the oral care time characteristic comprises calculating a moving average based on each subsequent oral care session.

6. (canceled)

7. A processing unit for encouraging a user to perform an oral care routine using an oral care device for a predetermined period of time, wherein the processing unit is adapted to:
obtain from a recording unit a plurality of recordings of oral care times for previous oral care sessions, the previous oral care sessions including at least one oral care session ending before the predetermined period of time has elapsed after the user has begun the oral care session;
calculate an oral care time characteristic based on the plurality of previous oral care sessions;
determine, for a subsequent oral care session, a point in time after the user has begun an oral care routine for providing the user with feedback based on the oral care time characteristic; and
generate a signal for controlling a feedback unit to provide the user with feedback at the determined point in time during the subsequent oral care session.

8. A system for encouraging a user to perform an oral care routine for a predetermined period of time, the system comprising:
an oral care device;
a recording unit adapted to record a plurality of oral care sessions;
a feedback unit;
a processing unit in communication with the recording unit and with the feedback unit and adapted to;
obtain from the recording unit the plurality of data collected during a plurality of previous oral care sessions including at least one oral care session ending before the predetermined period of time has elasped after the user has begun the oral care session;
calculate an oral care time characteristic based on the plurality of previous oral care sessions;
determine, for a subsequent oral care session, a point in time after the user has begun an oral care routine for providing the user with feedback based on the oral care time characteristic; and
generate a signal for controlling the feedback unit adapted to provide the user with feedback at the determined point in during the subsequent oral care session.

9. A system as claimed in claim 8, wherein the processing unit, the recording unit and the feedback unit are incorporated into the oral care device.

10. A system as claimed in claim 8, wherein the oral care device comprises one or more of:
a powered toothbrush;
a powered brushing mouthpiece;
a powered flossing device; and
a powered tooth whitening device.

11. A system as claimed in claim 10, wherein the recording unit comprises one or more of:
a timer;
a motion sensor;
a pressure sensor; and
a microphone.

12. A system as claimed in claim 8, wherein the processing unit is incorporated into a smart device comprising one or more of:
a smartphone;
a smartwatch; and
a smart home device;
and wherein the oral care device further comprises a communication unit in communication with the processing unit.

13. A system as claimed in claim 12, wherein:
the feedback unit is further incorporated into the smart device;
the feedback unit is incorporated into the oral care device, wherein the feedback unit is in communication with the communication unit; or
the feedback unit is incorporated into a charging unit, wherein the charging unit is adapted to charge the oral care device.

14. A system as claimed in claim 12, wherein:
the recording unit is incorporated into the smart device;
the recording unit is incorporated into the oral care device, wherein the recording unit is in communication with the communication unit or
the recording unit is incorporated into a charging unit, wherein the charging unit is adapted to charge the oral care device.

15. A system as claimed in claim 9, wherein the feedback unit comprises one or more of:
a light source;
a speaker;
a tactile feedback unit; and
an electrical signal generator.
